(19) United States
(12) Patent Application Publication
(10) Pub. No.: US 2015/0184042 A1
(43) Pub. Date: Jul. 2, 2015

(54) ADHESIVE COMPOSITION FOR SPINDLE MOTOR AND SPINDLE MOTOR MANUFACTURED BY USING THE SAME

(71) Applicant: SAMSUNG ELECTRO-MECHANICS CO., LTD., Gyeonggi-Do (KR)

(72) Inventors: Hyun Jung LEE, Gyeonggi-Do (KR); Hyung Kyu KIM, Gyeonggi-Do (KR); Kun KIM, Gyeonggi-Do (KR)

(73) Assignee: SAMSUNG ELECTRO-MECHANICS CO., LTD., Gyeonggi-Do (KR)

(21) Appl. No.: 14/541,750

(22) Filed: Nov. 14, 2014

(30) Foreign Application Priority Data
Dec. 27, 2013 (KR) 10-2013-0165924

(51) Int. Cl. C09J 163/00; C08K 3/22; H02K 7/08; C09J 11/04

(52) U.S. Cl. CPC C09J 163/00; C09J 11/04; C08K 3/22; H02K 7/086; C08K 2003/2241

(57) ABSTRACT

Embodiments of the invention provide an adhesive composition for a spindle motor and a spindle motor manufactured by using the same. According to at least one embodiment of the invention, there is provided an adhesive composition for a spindle motor, which includes a bisphenol-based epoxy resin, an acid anhydride; a hardener, and a stabilizer, thereby minimizing the occurrence of outgas and improving bonding strength.

### CROSS REFERENCE TO RELATED APPLICATION

This application claims the benefit of and priority under 35 U.S.C. §119 to Korean Patent Application No. KR 10-2013-0165924, entitled “ADHESIVE COMPOSITION FOR SPINDLE MOTOR AND SPINDLE MOTOR MANUFACTURED BY USING THE SAME,” filed on Dec. 27, 2013, which is hereby incorporated by reference in its entirety into this application.

### BACKGROUND

1. Field of the Invention

The present invention relates to an adhesive composition for a spindle motor and a spindle motor manufactured by using the same.

2. Description of the Related Art

A hard disk drive (HDD), which is an information storage device, has been widely used as a driver for a recording medium.

The hard disk drive is a storage device, which is configured of an electronic device and a mechanical device to change a digital electronic pulse to a more permanent magnetic field for recording and reproducing data. Thus, the hard disk drive is a storage device, which records data on a disk or reproduces the data recorded on the disk by a magnetic head having a predetermined height along a surface of the disk while the disk rotatably mounted on a spindle motor rotates.

The hard disk drive requires a disk driving device capable of driving the disk and as the disk driving device, the spindle motor is used. In the spindle motor, a fluid dynamic bearing assembly has been used. A shaft, which is one of the rotating members of the fluid dynamic bearing assembly and a sleeve, which is one of the fixed members thereof has a lubricating fluid interposed therebetween, such that the shaft is supported by a fluid pressure generated from the lubricating fluid.

In manufacturing the fluid dynamic bearing assembly, a UV adhesive and a primer have been used to bond between a base and the sleeve or a hub and the shaft.

However, errors are caused in a storage function of the hard disk drive motor due to the occurrence of outgas in case of using the UV adhesive and the primer as adhesive to make it difficult to secure a quality of reliability and the UV adhesive and the primer are simultaneously used to cause the problem of process performance. Recently, products subjected to surface treatment such as electroless nickel (Ni) plating, and the like for increasing rigidity of components against slimness of electronic products are increasing. In the case of the surface treated products, when the UV adhesive is used, adhesion may be remarkably reduced, and therefore instead of the UV adhesive, various attempts to apply a method for coupling between the base and the sleeve or the hub and the surface of the shaft using welding or other methods have been conducted.

Meanwhile, Korean Patent Publication No. 10-2001-0042398 discloses an effect of reducing the occurrence of outgas using an ultraviolet curable resin composition suitable for hard disk device assembling, but has a limitation of improvement of adhesion.

### SUMMARY

Accordingly, embodiments of the invention have been made to provide an adhesive composition for a spindle motor capable of minimizing the occurrence of outgas and improving bonding strength by applying a thermosetting resin composition as an adhesive to a rotor part and a stator part of a spindle motor, thereby securing excellent reliability.

Embodiments of the invention also provide a spindle motor capable of minimizing the occurrence of outgas and improving bonding strength by applying a thermosetting composition as an adhesive, thereby securing excellent reliability.

According to at least one embodiment, an adhesive composition for a spindle motor includes a bisphenol-based epoxy resin, an acid anhydride, a hardener, and a stabilizer.

According to at least one embodiment, the adhesive composition further includes titanium oxide, silica, boron compound, a coupling agent, or an accelerator.

According to at least one embodiment, the adhesive composition further includes 30 to 70 mass % of the bisphenol-based epoxy resin, 20 to 50 mass % of the acid anhydride, 1 to 20 mass % of the hardener, and 0.1 to 0.5 mass % of the stabilizer.

According to at least one embodiment, the bisphenol-based epoxy resin is at least one selected from the group consisting of bisphenol A epoxy, bisphenol F epoxy, modified bisphenol A epoxy, and modified bisphenol F epoxy.

According to at least one embodiment, the acid anhydride is at least one selected from the group consisting of tetrahydrophthalic anhydride, maleic anhydride, hexahydro-4-methylphthalic anhydride, and polyazelaic anhydride.

According to at least one embodiment, the hardener is at least one selected from the group consisting of an amine-based hardener, a triphenyl phosphate-based hardener, a dicyandiamide (DICY) hardener, a dihydrazide-based hardener, an epoxy amine adducts hardener, a polyamide hardener, and a phenol hardener.

According to at least one embodiment, the stabilizer is at least one selected from the group consisting of epoxy compound, organic phosphites, and carboxylic acid metal salts.

According to at least one embodiment, a spindle motor manufactured by using an adhesive composition includes a shaft, which is a driving shaft of a center of a motor, a sleeve penetratedly provided with a central hole into, which the shaft is inserted and supporting a rotation of the shaft, a base supporting an outer side of the sleeve and having an inner side provided with a core around which at least one winding coil is wound, and a hub coupled with the shaft, provided with a bent part of which the outside end is bent downward axially, and provided with a magnet formed in the bent part so as to be opposite to the core, wherein the adhesive composition including the bisphenol-based epoxy resin, the acid anhydride, the hardener, and the stabilizer is formed between the base and the sleeve.

According to at least one embodiment, the adhesive composition is formed between the hub and the shaft.

According to at least one embodiment, the adhesive composition further includes titanium oxide, silica, boron compound, a coupling agent, or an accelerator.

According to at least one embodiment, the adhesive composition includes 30 to 70 mass % of the bisphenol-based epoxy resin, 20 to 50 mass % of the acid anhydride, 1 to 20 mass % of the hardener, and 0.1 to 0.5 mass % of the stabilizer.

According to at least one embodiment, the bisphenol-based epoxy resin is at least one selected from the group consisting of bisphenol A epoxy, bisphenol F epoxy, modified bisphenol A epoxy, and modified bisphenol F epoxy.

According to at least one embodiment, the acid anhydride is at least one selected from the group consisting of tetrahydrophthalic anhydride, maleic anhydride, hexahydro-4-methylphthalic anhydride, and polyazelaic anhydride.

According to at least one embodiment, the hardener is at least one selected from the group consisting of an amine-based hardener, a triphenyl phosphate-based hardener, a dicyandiamide (DICY) hardener, a dihydrazide-based hardener, an epoxy amine adducts hardener, a polyamide hardener, and a phenol hardener.

According to at least one embodiment, the stabilizer is at least one selected from the group consisting of epoxy compound, organic phosphites, and carboxylic acid metal salts.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a diagram schematically illustrating a structure of a spindle motor according to an embodiment of the invention.

FIG. 2 is a cross-sectional view illustrating a portion at which an adhesive composition is applied to a spindle motor according to an embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, various embodiments of the present invention will be described in detail with reference to the accompanying drawings.

Adhesive Composition for Spindle Motor

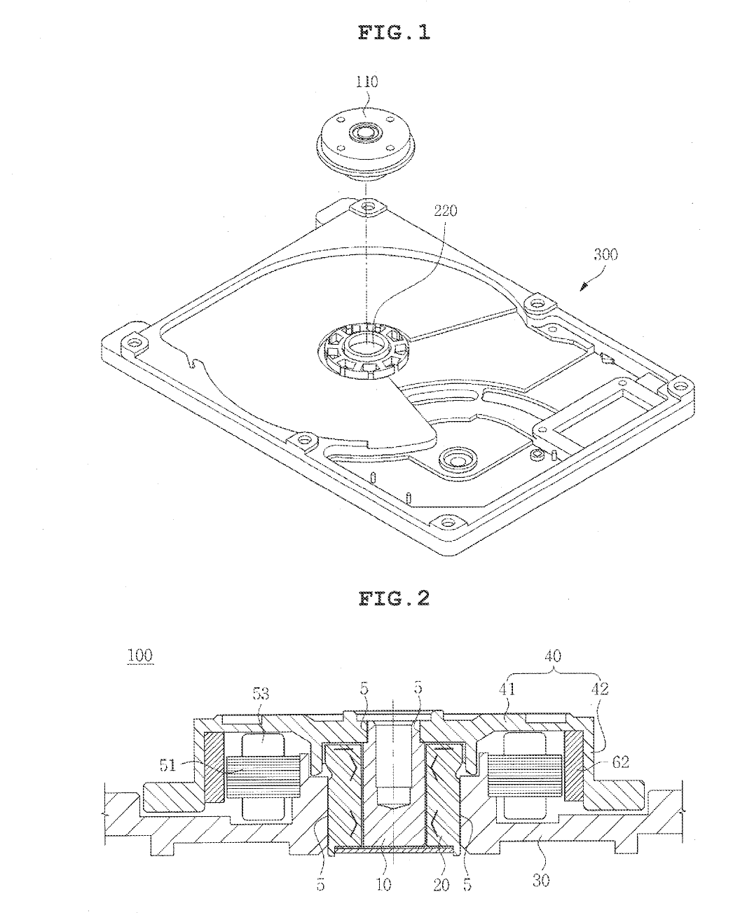

FIG. 1 is a diagram schematically illustrating a structure of a spindle motor according to an embodiment of the invention.

Referring to FIG. 1, an adhesive composition 5 for a spindle motor according to an embodiment of the invention relates to an adhesive composition for a spindle motor capable of minimizing the occurrence of outgas and improving bonding strength by applying a thermosetting resin composition as an adhesive to a rotor part 110 configured of a hub 40 and a shaft 10 and a stator part 220 configured of a base 30 and a sleeve 20 in a spindle motor 100, thereby securing excellent reliability.

According to at least one embodiment, the adhesive composition for a spindle motor includes bisphenol-based epoxy resin, acid anhydride, a hardener, and a stabilizer.

According to at least one embodiment, the thermosetting adhesive including the bisphenol-based epoxy resin may more minimize the occurrence amount of outgas and more remarkably improve bonding strength, compared to the existing UV adhesive. Further, film properties of hardened products are affected at the time of a hardening reaction of the adhesive composition.

According to at least one embodiment, the bisphenol-based epoxy resin is not particularly limited, but may be included as 30 to 70 mass % in the composition. When the epoxy resin is less than 30 mass %, properties of the adhesive composition is reduced and when the epoxy resin exceeds 70 mass %, a non-reaction material remains within the adhesive composition.

According to at least one embodiment, the bisphenol-based epoxy resin is not particularly limited, but may be at least one selected from the group consisting of bisphenol A epoxy resin, bisphenol F epoxy resin, modified bisphenol A epoxy resin, and modified bisphenol F epoxy resin.

According to at least one embodiment, the thermosetting adhesive including the acid anhydride improves adhesive property and impart functionality.

According to at least one embodiment, the acid anhydride is not particularly limited, but may be included as 20 to 50 mass % in the composition. When the acid anhydride is less than 20 mass %, a hardening rate is fast and thus a working-life of the adhesive is short or properties of the adhesive composition are reduced and when the acid anhydride exceeds 50 mass %, a hardening reaction is not generated well or a non-reaction material remains. Here, the working-life is defined as time until the adhesive is exposed to the air and thus is not used.

According to at least one embodiment, the acid anhydride is not particularly limited, but may be at least one selected from the group consisting of tetrahydrophthalic anhydride, maleic anhydride, hexahydro-4-methylphthalic anhydride, and polyazelaic anhydride.

According to at least one embodiment, the thermosetting adhesive including the hardener polymerizes the epoxy resin depending on a chemical reaction and a hardening reaction rate is improved.

The hardener is not particularly limited, but may be included as 1 to 20 mass % in the composition. When the hardener is less than 1 mass %, the hardening reaction of the epoxy resin is not smoothly progressed and thus a non-reaction material of the epoxy resin remains within the composition and when the hardener exceeds 20 mass %, an addition amount of the other remaining compositions is reduced and thus properties thereof are reduced or the non-reaction material of the hardener also remains.

According to at least one embodiment, the hardener is not particularly limited, but may be at least one selected from the group consisting of an amine-based hardener, a triphenyl phosphate-based hardener, a dicyandiamide (DICY) hardener, a dihydrazide-based hardener, an epoxy amine adducts hardener, a polyamide hardener, and a phenol hardener in the composition.

According to at least one embodiment, the thermosetting adhesive including the stabilizer serves to prevent other compositions from being changed due to an external environment.

According to at least one embodiment, the stabilizer is not particularly limited, but may be included as 0.1 to 0.5 mass % in the composition. When the stabilizer is less than 0.1 mass %, the stabilizer does not have an effect as the stabilizer of the composition and when the stabilizer exceeds 0.5 mass %, an addition amount of the other remaining composition is reduced and thus properties thereof are reduced or unwanted additional reaction is generated and thus properties thereof are reduced.

According to at least one embodiment, the stabilizer is not particularly limited, but may be at least one selected from the group consisting of epoxy compound, organic phosphites, and carboxylic acid metal salts.

According to at least one embodiment, the adhesive composition for a spindle motor furthers include titanium oxide, silica, boron compound, a coupling agent, or an accelerator.

According to at least one embodiment, the titanium oxide affects the adhesive property and properties of the hardened product and is not particularly limited but may include 1 part by mass for 100 parts by mass of the composition.

According to at least one embodiment, the silica affects the adhesion and properties of the hardened product and is not particularly limited but may include 5 parts by mass for 100 parts by mass of the composition.

According to at least one embodiment, the boron compound improves the film properties and frame retardancy of hardened product and is not particularly limited but may include 0.1 parts by mass for 100 parts by mass of the composition.

According to at least one embodiment, the coupling agent improves the adhesive property of the adhesive composition and is not particularly limited but may include 1 part by mass for 100 parts by mass of the composition. Further, the coupling agent may be selected from the group consisting of, for example, a silane-based coupling agent, an imidazole-based coupling agent, an imide-based coupling agent, an amine-based coupling agent, a thiol-based coupling agent, and a phenol-based coupling agent, but is not particularly limited thereto.

According to at least one embodiment, the accelerator improves reactivity of the epoxy resin and the film properties of the hardened products and is not particularly limited but may include 10 parts by mass for 100 parts by mass of the composition.

Spindle Motor

FIG. 2 is a cross-sectional view illustrating a portion at which an adhesive composition is applied to a spindle motor according to an embodiment of the invention.

Referring to FIG. 2, the spindle motor 100 according to an embodiment of the present invention includes a shaft 10, which is a driving shaft of a center of a motor, a sleeve 20 penetratedly provided with a central hole into which the shaft 10 is inserted and supporting a rotation of the shaft 10, a base 30 supporting an outer side of the sleeve 20 and having an inner side provided with a core 53 around which at least one winding coil 51 is wound, and a hub 40 coupled with the shaft 10, provided with a bent part 42 of which the outside end is bent downward axially, and provided with a magnet 62 formed in the bent part 42 so as to be opposite to the core 53, in which the adhesive composition including the bisphenol-based epoxy resin, the acid anhydride, the hardener, and the stabilizer are formed between the base 30 and the sleeve 20.

First, defining terms relating to a direction, an axial direction means a vertical direction based on the shaft 10 in FIG. 2.

According to at least one embodiment, the shaft 10 forms a central axis on which the spindle motor 100 rotates and generally has a cylindrical shape. The shaft 10 is for shaft-supporting the hub 40 and is inserted into the central hole penetratedly formed in the sleeve 20 and is rotatably supported by the sleeve 20.

According to at least one embodiment, the sleeve 20 supports the rotation of the shaft 10 inserted thereinto and an upper end of the shaft 10 supports the shaft 10 protruding upward axially. Further, the sleeve 20 has a hollow cylindrical shape and thus accommodates the shaft 10, which is inserted into the hollow. The sleeve 20 is formed, for example, by forging copper (Cu) or aluminum (Al) or sintering a Cu—Fe-based alloy powder or an SUS-based powder. Although not illustrated in FIG. 2, a radial dynamic pressure bearing part is formed between an outer circumferential surface of the sleeve 20 and an inner circumferential surface of the shaft 10 opposite thereto.

According to at least one embodiment, the base 30 supports the outer side of the sleeve 20 and has an inner side provided with the core 53 around which at least one winding coil 51 is wound. The base 30 forms the stator part 220 along with the sleeve 20.

According to at least one embodiment, the base 30 has one surface coupled with the outer circumferential surface of the sleeve 20 to enclose the outer circumferential surface of the sleeve 20 so that the sleeve 20 including the shaft 10 is coupled with the inner side thereof. The other surface opposite to one surface of the base 30 is coupled with the core 53 around which the winding coil 51 is wound so that the core 53 is opposite to the magnet 63 mounted in an inner side of the hub 40. The base 30 serves to support the entire structure of the spindle motor 100 at a lower portion of the spindle motor 100 and is manufactured, for example, by press processing method or die-casting method. The press processing is performed using metals of various materials such as aluminum, steel, as non-limiting examples, particularly, a metal material having rigidity.

Further, the adhesive composition including the bisphenol-based epoxy resin, the acid anhydride, the hardener, and the stabilizer according to an embodiment of the invention is formed between the base 30 and the sleeve 20, thereby minimizing the occurrence of outgas and improving the bonding strength.

According to at least one embodiment, the hub 40 is a rotating structure, which is rotatably provided with respect to the stator part 220 including the base 30 and the sleeve 20 and a plate 41 at an axial upper end and the bent part 42 of which the outside end is bent downward axially is formed. The hub 40 has a center integrally coupled with the shaft 10 and is coupled with an upper portion of the shaft 10 to correspond to an axial upper end surface of the sleeve 20. Further, the inner side of the bent part 42 is provided with the magnet 62 formed to be opposite to the core 53.

When a current flows in the core 53, a magnetic flux is generated while forming a magnetic field. The magnet 62 opposite to the core 53 may include N and S poles repeatedly magnetized in a circumferential direction to form an electrode corresponding to a variable electrode generated in the core 53. A repulsive force is generated between the core 53 and the magnet 62 by an electromagnetic force depending on an interlinkage of magnetic flux, such that the hub 40 and the shaft 10 coupled therewith rotate.

Further, the adhesive composition according to an embodiment of the invention is formed between the hub 40 and the shaft 10, thereby minimizing the occurrence of outgas and improving the bonding strength.

Therefore, the adhesive composition according to an embodiment of the invention is applied to the rotor part 110 and the stator part 220 of the spindle motor 100, respectively, thereby minimizing the occurrence of outgas and improving the bonding strength.

In the adhesive composition 5 used in the spindle motor 100 according to an embodiment of the invention, the composition includes 30 to 70 mass % of bisphenol-based epoxy resin, 20 to 50 mass % of acid anhydride, 1 to 20 mass % of hardener, and 0.1 to 0.5 mass % of stabilizer.

According to at least one embodiment of the invention, the adhesive composition further includes the titanium oxide, the silica, the boron compound, the coupling agent, or the accelerator.

According to at least one embodiment of the invention, the bisphenol-based epoxy resin is at least one selected from the group consisting of bisphenol A epoxy, bisphenol F epoxy, modified bisphenol A epoxy, and modified bisphenol F epoxy.

According to at least one embodiment of the invention, the acid anhydride is at least one selected from the group consisting of tetrahydrophthalic anhydride, maleic anhydride, hexahydro-4-methylphthalic anhydride, and polyazelaic anhydride.

According to at least one embodiment of the invention, the hardener is at least one selected from the group consisting of an amine-based hardener, a triphenyl phosphate-based hardener, a dicyandiamide (DICY) hardener, a dihydrazide-based hardener, an epoxy amine adducts hardener, a polyamide hardener, and a phenol hardener.

According to at least one embodiment of the invention, the stabilizer is at least one selected from the group consisting of epoxy compound, organic phosphites, and carboxylic acid metal salts.

Hereinafter, various embodiments of the invention will be described in more detail with reference to Examples and Comparative Examples, but the scope of the various embodiments of the invention are not limited to the following Example.

### Example 1

Varnish was prepared by mixing 35 g of bisphenol A type epoxy resin, 25 g of bisphenol F type epoxy resin, 30 g of the tetrahydrophthalic anhydride, 10 g of the dicyandiamide (DICY) hardener, and 0.1 g of the stabilizer. Next, about 1 mg of the varnish was coated on the base and the sleeve is assembled and then was hardened at a temperature of about 90° C. for about 1 hour.

### Example 2

Varnish was prepared by additionally mixing 35 g of the bisphenol A type epoxy resin, 25 g of the bisphenol F type epoxy resin, 40 g of the polyamide hardener, and 0.1 g of the stabilizer. Next, about 1 mg of the varnish was coated on the base and the sleeve is assembled and then was hardened at a temperature of about 90° C. for about 1 hour.

### Example 3

A mixture of 35 g of the bisphenol A type epoxy resin, 25 g of the bisphenol F type epoxy resin, 0.5 g of the titanium oxide, and 0.05 g of the boron compound was dispersed by a bead mill. The varnish was prepared by mixing the mixture with 30 g of the hexahydro-4-methylphthalic anhydride, 9 g of dicyandiamide (DICY) hardener, 1 g of the accelerator, 0.1 g of the stabilizer, and 0.5 g of the coupling agent. Next, about 1 mg of the varnish was coated on the base and the sleeve is assembled and then was hardened at a temperature of about 90° C. for about 1 hour.

### Comparative Example 1

The varnish was prepared by mixing 45 g of urethane methacrylate oligomer, 45 g of hydroxylalkyl methacrylate, and 1 g of acrylic acid and then mixing 1.5 g of organic hydro peroxide and 2.5 g of photo initiator. Next, about 1 mg of the varnish was coated on the base and a primer was coated on the entire sleeve surface and then these parts were assembled. The assembled parts were hardened by being irradiated by about 3500 mJ/cm² metal halide light. Further, to reduce the outgas, the assembled parts were left at a temperature of about 90° C. for about 1 hour.

Characteristics Evaluation of Adhesive

The bonding strength between the base and the sleeve to which the adhesive composition prepared according to the above Examples and Comparative Example is applied and the occurrence of outgas after the hardening were measured.

The bonding strength was measured by using a force measurement (load tester) device. The bonding strength between the base and the sleeve was measured while increasing a load applied to the sleeve surface by the measurement device on which the assembled base and sleeve are put. When the load is applied to the sleeve, the bonding strength was measured by reading a point at which the sleeve is separated.

The measurement of the occurrence of outgas analyzed the outgas amount using a gas chromatography/mass spectroscopy analysis method. A sample of the hardened adhesive composition is put in an outgas analysis chamber and an outgas portion of the chamber is mounted with a gas adsorption tube. Gas from the sample while nitrogen flows at a temperature of about 85° C. for about 3 hours was collected in the adsorption tube and then the adsorption tube was analyzed by the GC/MS to calculate a detection amount.

TABLE 1

| | | Occurrence Of Outgas |
|---|---|---|
| Division | Bonding Strength (kgf) | After Hardening (ppm) |
| Example 1 | 42 | 2 |
| Example 2 | 30 | 2 |
| Example 3 | 48 | 10 |
| Comparative | 13 | 12,348 |
| Example 1 | | |

As can be appreciated from the above Table 1, it may be appreciated that the sample of the adhesive according to Examples 1, 2, and 3 prepared by the adhesive composition according to the present disclosure shows the excellent effect two times as large as the bonding strength of the above Comparative Example 1 prepared by the existing adhesive composition. Further, it may be appreciated that the samples of the adhesive according to the above Examples 1, 2, and 3 discharge the occurrence amount of outgas after the hardening at a small amount beyond comparing to the sample of the above Comparative Example 1.

As set forth above, according to various embodiments of the invention, in the adhesive composition for the spindle motor, it is possible to minimize the occurrence of outgas by using the adhesive composition including the bisphenol-based epoxy resin, the acid anhydride, the hardener, and the stabilizer.

Further, according to various embodiments of the invention, in the adhesive composition for the spindle motor, it is possible to improve the bonding strength by using the adhesive composition including the bisphenol-based epoxy resin, the acid anhydride, the hardener, and the stabilizer.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. An adhesive composition for a spindle motor, comprising:
a bisphenol-based epoxy resin;
an acid anhydride;
a hardener; and
a stabilizer.

2. The adhesive composition for a spindle motor of claim 1, further comprising:
titanium oxide, silica, boron compound, a coupling agent, or an accelerator.

3. The adhesive composition for a spindle motor of claim 1, wherein a content of the bisphenol-based epoxy resin is 30 to 70 mass %, a content of the acid anhydride is 20 to 50 mass %, a content of the hardener is 1 to 20 mass %, and a content of the stabilizer is 0.1 to 0.5 mass %.

4. The adhesive composition for a spindle motor of claim 1, wherein the bisphenol-based epoxy resin is at least one selected from the group consisting of bisphenol A epoxy, bisphenol F epoxy, modified bisphenol A epoxy, and modified bisphenol F epoxy.

5. The adhesive composition for a spindle motor of claim 1, wherein the acid anhydride is at least one selected from the group consisting of tetrahydrophthalic anhydride, maleic anhydride, hexahydro-4-methylphthalic anhydride, and polyazelaic anhydride.

6. The adhesive composition for a spindle motor of claim 1, wherein the hardener is at least one selected from the group consisting of an amine-based hardener, a triphenyl phosphate-based hardener, a dicyandiamide (DICY) hardener, a dihydrazide-based hardener, an epoxy amine adducts hardener, a polyamide hardener, and a phenol hardener.

7. The adhesive composition for a spindle motor of claim 1, wherein the stabilizer is at least one selected from the group consisting of epoxy compound, organic phosphites, and carboxylic acid metal salts.

8. A spindle motor manufactured by using an adhesive composition, comprising:
a shaft which is a driving shaft of a center of a motor;
a sleeve penetratedly provided with a central hole into which the shaft is inserted and supporting a rotation of the shaft;
a base supporting an outer side of the sleeve and having an inner side provided with a core around which at least one winding coil is wound; and
a hub coupled with the shaft, provided with a bent part of which an outside end is bent downward axially, and provided with a magnet formed in the bent part so as to be opposite to the core,
wherein the adhesive composition including the bisphenol-based epoxy resin, acid anhydride, hardener, and stabilizer is formed between the base and the sleeve.

9. The spindle motor of claim 8, wherein the adhesive composition is formed between the hub and the shaft.

10. The spindle motor of claim 8, wherein the adhesive composition further comprises titanium oxide, silica, boron compound, a coupling agent, or an accelerator.

11. The spindle motor of claim 8, wherein the adhesive composition comprises 30 to 70 mass % of the bisphenol-based epoxy resin, 20 to 50 mass % of the acid anhydride, 1 to 20 mass % of the hardener, and 0.1 to 0.5 mass % of the stabilizer.

12. The spindle motor of claim 8, wherein the bisphenol-based epoxy resin is at least one selected from the group consisting of bisphenol A epoxy, bisphenol F epoxy, modified bisphenol A epoxy, and modified bisphenol F epoxy.

13. The spindle motor of claim 8, wherein the acid anhydride is at least one selected from the group consisting of tetrahydrophthalic anhydride, maleic anhydride, hexahydro-4-methylphthalic anhydride, and polyazelaic anhydride.

14. The spindle motor of claim 8, wherein the hardener is at least one selected from the group consisting of an amine-based hardener, a triphenyl phosphate-based hardener, a dicyandiamide (DICY) hardener, a dihydrazide-based hardener, an epoxy amine adducts hardener, a polyamide hardener, and a phenol hardener.

15. The spindle motor of claim 8, wherein the stabilizer is at least one selected from the group consisting of epoxy compound, organic phosphites, and carboxylic acid metal salts.
